(19) United States
(12) Patent Application Publication
(10) Pub. No.: US 2002/0186878 A1
(43) Pub. Date: Dec. 12, 2002

(54) System and method for multiple image analysis

(76) Inventors: Tan Seow Hoon, Singapore (SG); Sreenivas Rao, Bangalore (IN)

Correspondence Address: CHRISTOPHER J. ROURK, AKIN, GUMP, STRAUSS, HAUER & FELD, L.L.P., P O BOX 688, DALLAS, TX, 75313-0688, US

(21) Appl. No.: 09/876,795

(22) Filed: Jun. 7, 2001

(51) Int. Cl. G06K 9/00

(52) U.S. Cl. 382/149; 382/154

(57) ABSTRACT

A system for analyzing multiple images is provided, such as to locate defects in a test component. The system includes a first light source, such as one that emits blue light, and a second light source, such as one that emits red light. The system also includes a camera, where the camera and the light sources are focused on an area where a test piece is to be placed. A multiple image processor is connected to the first light source, the second light source, and the camera. The multiple image processor causes the first light source and the second light source to turn on, such as in sequence, and also causes the camera to generate two or more sets of image data, such as one set when each of the light sources is illuminated, through the use of filters or tuned pixels, or otherwise.

### FIELD OF THE INVENTION

The present invention pertains to the field of semiconductor devices, and more particularly to a system and method for inspecting semiconductor devices that uses multiple two-dimensional images to generate third dimension data.

### BACKGROUND OF THE INVENTION

Image data analysis systems for inspecting semiconductor components are known in the art. Such image data analysis systems attempt to determine the state of the semiconducting component or other inspected components by analyzing image data, which is typically comprised of an N×M array of picture elements or “pixels.” The brightness value of each pixel of a test image is typically compared to the brightness element of a corresponding pixel of a reference image, and the comparison data is analyzed to determine whether or not unacceptable defects exist on the semiconducting device, component or other object being inspected. For example, image data analysis is used to determine whether the variation in the dimensions of an element of the component exceed allowable tolerances for such dimensions.

One drawback with known image data inspection systems is the difficulty in determining the three-dimensional nature of elements. Such image data is typically taken from a single angle, such that any three-dimensional aspects or flaws may be difficult to detect. For example, a common method for determining the three-dimensional aspects of a semiconductor device or component that is being inspected is to use a laser beam to trace a line, and to determine when the line varies from a straight line, where such variations are then correlated to defects in the semiconducting device or component. When the semiconducting device or component contains a large number of elements, it is necessary to trace a laser line through each of the elements, which can require movement of the component to a number of different locations. Likewise, it is possible that the laser drawn line may not lie on a defect, such that the defect could be missed.

Thus, although it is known to perform analysis of image data of a component to determine whether variations in the dimensions of elements of the component exceed allowable tolerances, the determination of such dimensional variations in three dimensions is time-consuming and limited to small portions of the component.

### BRIEF SUMMARY OF THE INVENTION

In accordance with the present invention, a system and method for multiple image analysis are provided that overcome known problems with analyzing image data.

In particular, a system and method for multiple image analysis are provided that use image data generated by illuminating a component from two or more lighting angles, which allows three-dimensional aspects of the component to be determined.

In accordance with an exemplary embodiment of the present invention, a system for analyzing multiple images is provided, such as to locate defects in a test component. The system includes a first light source, such as one that emits blue light, and a second light source, such as one that emits red light. The system also includes a camera, where the camera and the light sources are focused on an area where a test piece is to be placed. A multiple image processor is connected to the first light source, the second light source, and the camera. The multiple image processor causes the first light source and the second light source to turn on, such as in sequence, and also causes the camera to generate two or more sets of image data, such as one set when each of the light sources is illuminated, through the use of filters or tuned pixels, or otherwise.

The present invention provides many important technical advantages. One important technical advantage of the present invention is a system and method for multiple image analysis that uses two or more sets of image data to analyze a component. Each set of image data is obtained when the component is illuminated by a light source having a different lighting angle, which creates shaded areas that can be analyzed to determine whether they indicate the existence of damage or unacceptable dimensional variations on the component.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for performing multiple image analysis in accordance with an exemplary embodiment of the present invention;

FIGS. 2A, 2B, and 2C show an exemplary undamaged element and corresponding bright and shaded regions generated by illumination from light sources;

FIGS. 3A, 3B, and 3C show an exemplary damaged element and corresponding bright and shaded regions generated by illumination from light sources;

FIG. 4 is a diagram of a system for processing image data from multiple images in accordance with an exemplary embodiment of the present invention;

FIG. 5 is a flowchart of a method for analyzing image data from multiple images in accordance with an exemplary embodiment of the present invention;

FIG. 6 is a flowchart of a method for analyzing image data in accordance with an exemplary embodiment of the present invention; and

FIG. 7 is a flowchart of a method for performing image data analysis for multiple images in accordance with an exemplary embodiment of the present invention.

### DETAILED DESCRIPTION OF THE INVENTION

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

FIG. 1 is a diagram of a system 100 for performing multiple image analysis in accordance with an exemplary embodiment of the present invention. System 100 allows three-dimensional aspects of an inspected device or component to be determined from images obtained from two or more different viewing angles.

System 100 includes multiple image processor 102, which can be implemented in hardware, software, or a suitable combination of hardware and software, and which can be one or more software systems operating on a general purpose processing platform. As used herein, a software system can include one or more objects, agents, subroutines, lines of code, threads, two or more lines of code or other suitable software structures operating in two or more separate software applications, or other suitable software structures, and can operate on two or more different processors, or other suitable configurations of processors. In one exemplary embodiment, a software system can include one or more lines of code or other software structures operating in a general purpose software application, such as an operating system, and one or more lines of code or other suitable software structures operating in a specific purpose software application.

Multiple image processor 102 is coupled to light sources 104a and 104b. As used herein, the term “couple,” and its cognate terms such as “couples” and “coupled,” can include a physical connection (such as a copper conductor), a virtual connection (such as through one or more randomly assigned data memory locations of a data memory device), a logical connection (such as through one or more logical gates of a semiconducting device), a wireless connection, other suitable connections, or a suitable combination of such connections. In one exemplary embodiment, systems and components are coupled to other systems and components through intervening systems and components, such as through an operating system of a general purpose processor platform.

Multiple image processor 102 is also coupled to camera 106. Camera 106 can be a charge coupled device (CCD), a CMOS imaging device, or other suitable imaging devices that are focused on a component 108 having a plurality of elements 110. Light sources 104a and 104b are also focused on component 108, and illuminate component 108 from different angles as shown in FIG. 1. Thus, the light illuminating component 108 from light source 104a will create shaded regions that are different from the shaded regions created by light illuminating component 108 from light source 104b. Additional light sources can be used where suitable to create additional shaded regions.

Camera 106 is used to record image data of component 108 while it is being illuminated by light sources 104a and 104b. In one exemplary embodiment, camera 106 is controlled by multiple image processor 102 to store a first set of image data of component 108 when light source 104a is on, and to store a second set of image data when light source 104b is on. Likewise, camera 106 can store image data when both of light sources 104a and 104b are on, such as when the light sources use different frequencies of light. For example, camera 106 can record image data according to the frequency of the light that creates the image, such as by including one or more light filters, two or more sets of pixels that are tuned to received predetermined frequencies of light, or to otherwise differentiate between light illuminated from light sources 104a and 104b, such that multiple sets of image data can be concurrently gathered.

In operation, a component 108 is placed in the focal area of light sources 104a and 104b and camera 106 for inspection. Multiple image processor 102 then causes component 108 to be illuminated and causes camera 106 to produce image data, such as by generating an N×M array of pixels of image data, which can then be stored by multiple image processor 102 or other suitable storage systems or devices. Because of the angular difference between light sources 104a and 104b relative to component 108, shaded regions are generated from elements 110. Multiple image processor 102 can analyze these shaded regions to determine whether they are indicative of any damage or defects to component 108, elements 110, or other suitable indications.

In this manner, multiple image processor 102 can determine whether three-dimensional defects or other variations in component 108 or elements 110 exist. For example, if one of elements 110 is damaged, then the shaded regions generated by that element 110 when it is illuminated by light sources 104a and 104b will vary from the shaded regions generated for undamaged reference images. Furthermore, the variations in pixel brightness between corresponding pixels of the test image data and the reference image data, as illuminated by light sources 104a and 104b, can also be analyzed to generate an approximation of differences in height, dimensions, or other data that can be used to approximate a three-dimensional analysis.

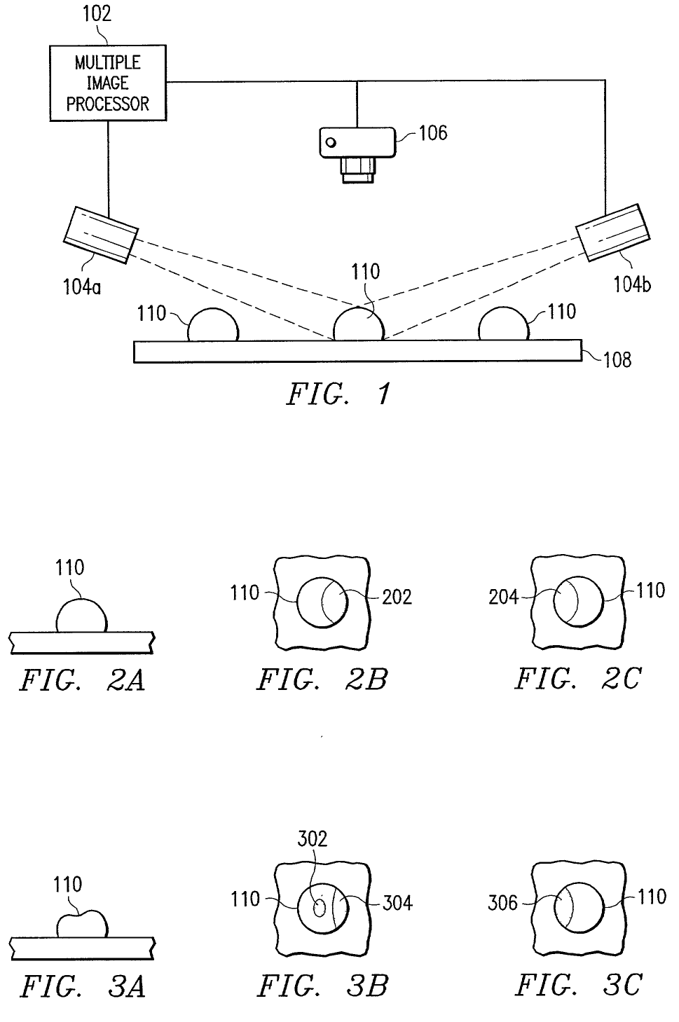

FIGS. 2A, 2B, and 2C show an exemplary undamaged element 110 and corresponding bright and shaded regions generated by illumination from light sources 104a and 104b (not explicitly shown).

FIG. 2A shows an exemplary undamaged element 110, which is semi-spherical in shape. In FIG. 2B, the circular outline of element 110 as viewed from overhead is shown with an illuminated region and a shaded region corresponding to the shadow generated by light source 104a. As shown, the shaded region generates a distinctive pattern which is indicative of a spherical configuration of element 110. Likewise, in FIG. 2C, the shaded region of element 110 is on the opposite face, as a result of the location of light source 104b. Thus, the shaded regions generated shown in FIGS. 2b and 2c can be used as a reference for an undamaged element 110.

In addition, the differences in pixel brightness data between FIG. 2B and FIG. 2C and the known angle of illumination from light sources 104a and 104b can also be used to estimate the dimensional variations of element 110. For example, it can be determined from areas in FIG. 2B and FIG. 2C in which the pixel brightness data is a maximum and does not vary that such areas are not directly blocked from direct exposure by either source. Likewise, as the difference in brightness data increases for a given pixel of FIG. 2B and FIG. 2C, it can be determined that an obstruction is blocking those pixels, and that the obstruction is located between light source having the lower brightness values and the location of the pixel being analyzed. Other suitable procedures can be used to estimate the size and location of dimensional variations based upon pixel data, such as the use of empirically developed pass/fail ratios based upon the size of areas in which pixel brightness variations between two or more images exceed predetermined levels.

FIGS. 3A, 3B, and 3C show an exemplary damaged element 110 and corresponding bright and shaded regions generated by illumination from light sources 104a and 104b (not explicitly shown).

FIG. 3A shows the damaged element 110 which varies from semi-circular, such as by an indentation. As shown in FIG. 3B, this indentation creates shaded regions 302 and 304. These shaded regions 302 and 304 are different from shaded region 202 in FIG. 2b. These exemplary variations can be used to detect three-dimensional variations in element 110 that would otherwise be difficult to detect from a single image, depending on the angle of illumination. Likewise, FIG. 3C includes shaded region 306 which varies from shaded region 204. The pixels defining these regions can be compared between a test image, such as that shown in FIG. 3B and FIG. 3C, and a reference image, such as that shown in FIG. 2B and FIG. 2C, to determine whether the region defined by such pixel variations exceeds predetermined allowable areas for defects. Likewise, the composite images formed by combining image data from shaded regions 202 and 204 with FIGS. 3B and 3C can be used and compared, so as to generate additional comparison points. The variations in pixel brightness between the reference images and test images can also be used, in conjunction with the known angular position of light sources, to estimate the location and size of obstructions, deformations, or other features.

In operation, the shaded regions generated by illumination from light sources 104a and 104b can be used to generate three-dimensional image data from two dimensional image data. Pixel brightness data can also be used to estimate the dimensional variations between a test image and a reference image.

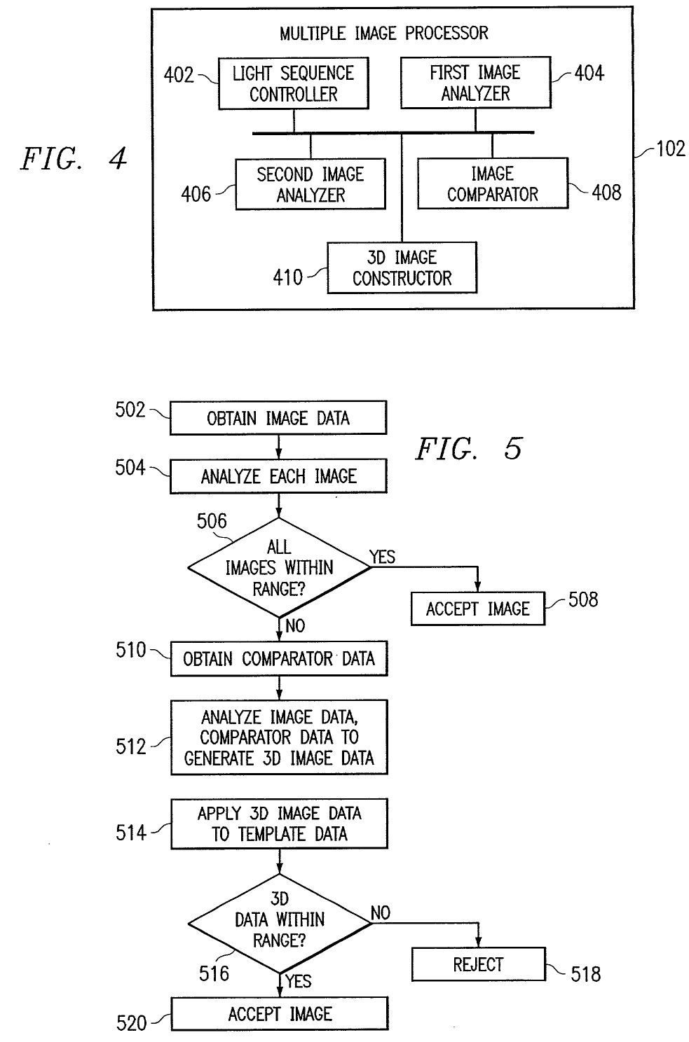

FIG. 4 is a diagram of a system 400 for processing image data from multiple images in accordance with an exemplary embodiment of the present invention. System 400 includes multiple image processor 102 and light sequence controller 402, first image analyzer 404, second image analyzer 406, image comparator 408, and 3D image constructor 410, each of which can be implemented in hardware, software, or a suitable combination of hardware and software, and which can be one or more software systems operating on a general purpose processor platform.

Light sequence controller 402 controls the sequence in which light sources 104a, 104b, and other suitable lights illuminate a component 108. Likewise, light sequence controller 402 also controls the operation of camera 106, such that when a first light source is illuminating the component 108, camera 106 captures first image data, and when a second light source is illuminating the component 108, camera 106 captures or generates second image data. Likewise, light sequence controller 402 can control light sources having different frequencies, such that camera 106 can generate multiple sets of image data simultaneously so as to decrease the amount of time required to generate the multiple sets of image data.

First image analyzer 404 and second image analyzer 406 receive an N×M array of pixels of brightness data, and analyze the pixel data to determine whether the pixel data is acceptable, requires additional analysis such as comparison with a reference image or dimensional analysis, or is unacceptable. First image analyzer 404 and second image analyzer 406 then generate status data indicating whether the pixel data is acceptable, requires further analysis, or is unacceptable. In one exemplary embodiment, first image analyzer 404 receives pixel array data generated when light source 104a illuminates component 108 and second image analyzer 406 receives pixel array data generated when light source 104b illuminates component 108. Additional image analyzers can also be used to accommodate light sources illuminating the component 108 from different angles. First image analyzer 404 and second image analyzer 406 perform pixel brightness analysis of the corresponding images.

In one exemplary embodiment, first image analyzer 404 and second image analyzer 406 determine whether the pixel data indicates that the number and magnitude of variations in pixel brightness data exceed predetermined maximum allowable numbers and magnitudes, such that it is determinable whether the component contains unacceptable dimensional variations without additional image data analysis. In addition, first image analyzer 404 and second image analyzer 406 can determine whether the pixel data falls within a range of values that indicates that further analysis is required.

Image comparator 408 receives first image data and second image data and generates difference image data, such as by subtracting pixel brightness data for corresponding pixels between a first image and a second image. Image comparator 408 can perform comparator analysis of first test image data and first reference image data, second test image data and second reference image data, composite test image data and composite reference image data, or other suitable sets of corresponding image data. Image comparator 408 can also generate absolute brightness variation data, relative brightness variation data, or other suitable brightness variation data.

3D image constructor 410 can receive the test image data, reference image data, difference image data, composite image data, or other suitable image data and determine whether defects, variations, or other features of element 110 or other elements exceed allowable variations for such elements. In one exemplary embodiment, 3D image constructor 410 can determine from the known angle of illumination of light sources 104a, 104b and other light sources, and from the brightness values of pixels generated when such light sources illuminate the component, whether the light source is illuminating the feature or element 110 at that corresponding position. Likewise, 3D image constructor 410 can include predetermined ranges for allowable variations, such as histogram data, pixel area mapping data, and other suitable data. In this manner, 3D image constructor 410 can be used to generate dimensional variation data after determining whether a variation or feature in an element 110 exceeds allowable limits, such that the component having the element can be rejected in the event the damage or dimensional variation in the element 110 exceeds such limits.

In operation, system 400 is used to control the inspection of a component, to generate test image data, to analyze the test image data, and to estimate three-dimensional variations or features of a test image. System 400 utilizes image data generated by illuminating the component from two or more angles, can combine the test image data and compare the test image data to reference image data, and can process any difference image data to make determinations on whether or not to accept or reject a component.

FIG. 5 is a flowchart of a method 500 for analyzing image data from multiple images in accordance with an exemplary embodiment of the present invention. Method 500 can be used to perform component image analysis to detect damaged components, or for other suitable purposes.

Method 500 begins at 502 where image data is obtained. In one exemplary embodiment, the image data is obtained by simultaneously illuminating a component with multiple light sources from different angles, where each light source is illuminated at a different time. Likewise, the light sources can provide light having different frequencies where the image data is generated at the same time and filters, tuned pixels, or other procedures are used to separate the image data created from each light source. The method then proceeds to 504.

At 504 each set of image data is analyzed. The sets of image data can be analyzed by generating histogram data showing the brightness of each pixel, by comparing each set of test image data to a set of reference image data and performing histogram analysis or other suitable analysis of the difference image data set, by combining the test image data and comparing the combined test image data to predetermined acceptable ranges for histogram data, by comparing the combined test image data to combined reference image data, or performing other suitable analyses. The method then proceeds to 506.

At 506 it is determined whether all images are within an acceptable predetermined range. If all images are within such range, the method proceeds to 508 where the image is accepted and any subsequent analysis is performed on that component, other components can be selected for analysis, or other suitable procedures can be implemented. Otherwise the method proceeds to 510.

At 510 compared image data is obtained. In one exemplary embodiment, an initial analysis is performed at 504 to determine whether additional analyses need to be performed, such that the analysis performed at 504 does not include comparator data. Other suitable processes can be used. After the comparator image data is obtained for each single test image and reference image, composite test and reference images, or other suitable comparative data, the method proceeds to 512.

At 512 the image data and comparator data is analyzed to generate three-dimensional image data. In one exemplary embodiment, the three-dimensional image data can include predetermined allowable ranges for three-dimensional variations that generate shaded regions of elements when illuminated by multiple light sources. Likewise, the three-dimensional image data can include estimates of variations and components based upon the known angular relationship between the light sources and the component. The method then proceeds to 514.

At 514 the three-dimensional image data is applied to template data. In one exemplary embodiment, the template data can include one or more templates that are used to estimate variations between measured brightness data and expected brightness data, so as to determine whether three-dimensional variations in the inspected component exceed allowable variations. The method then proceeds to 516.

At 516 it is determined whether the three-dimensional data is within a predetermined range. If the three-dimensional data is not within the range, the method proceeds to 518 where the image data is rejected, such as by rejecting the component, flagging the component for further manual inspection, or other suitable procedures. Otherwise, the method proceeds to 520 where the image data is accepted.

In operation, method 500 is used to analyze multiple sets of image data for a test component in order to determine whether the component includes dimensional variations, damage, or other unacceptable condition. Method 500 further utilizes light sources having different angular relationships to the test component, where the known angular relationship of the light sources can be used in conjunction with the pixel brightness data to estimate 3-dimensional variations in the test component.

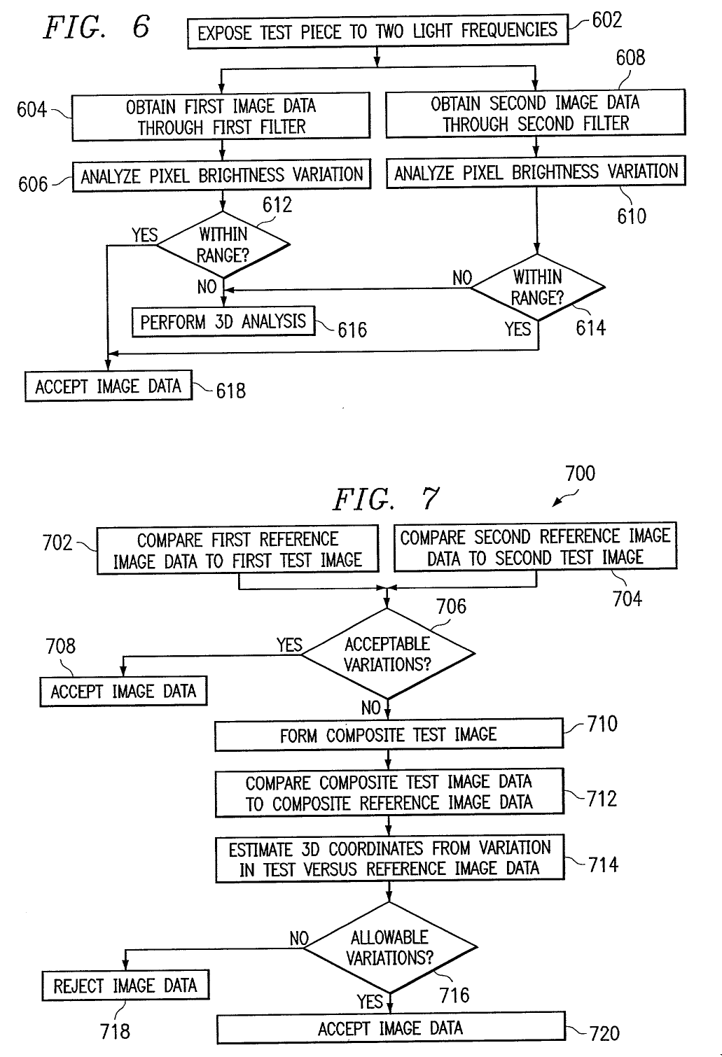

FIG. 6 is a flowchart of a method 600 for analyzing image data in accordance with an exemplary embodiment of the present invention. Method 600 can be used to perform component image analysis to detect damaged components, or for other suitable purposes.

Method 600 begins at 602 where a test piece is exposed to light from two different light frequencies and two different angular illumination zones. The method then proceeds to 604 and 608 in parallel. At 604, first image data is obtained, such as by filtering the light through a first filter, by using pixels tuned to the first light frequency, or other suitable methods. Likewise, at 608, the second image data is obtained, such as by filtering the light through a second filter, by using pixels tuned to a second light frequency, or other suitable methods. The method then proceeds to 606 from 604 and 610 from 608, respectively.

At 606, the pixel brightness variation data is analyzed for the first image data. For example, pixel histogram data can be generated and the variations in pixel brightness can be compared to predetermined acceptable ranges. Likewise, other suitable pixel brightness variation analysis methods can be used. At 610, similar pixel brightness variations are analyzed for the second image data. The method then proceeds to 612 and 614, respectively.

At 612 and 614 it is determined whether the variations in pixel brightness for the first image data and the second image data are within a predetermined range. If both sets of image data have acceptable variations then the method proceeds to 618 and the image data is accepted. Likewise, if either of the images has unacceptable range variations the method proceeds to 616 where three-dimensional analysis is performed to determine whether the dimensional variations in the test piece are acceptable.

In operation, method 600 can be used to determine whether three-dimensional analysis of component image data should be performed, such as to perform a quick preliminary component image inspection analysis for the purpose of determining whether additional analysis should be performed. Method 600 also allows image data to be analyzed in parallel where suitable, such as when a parallel processor platform is being used to analyze the image data. Alternatively, method 600 can be implemented on a general purpose processing platform, such as through the use of multitasking or by otherwise simulating parallel processing.

FIG. 7 is a flowchart of a method 700 for performing image data analysis for multiple images in accordance with an exemplary embodiment of the present invention. Method 700 can be used to perform component image analysis to detect damaged components, or for other suitable purposes.

Method 700 begins at 702 and 704 in parallel. At 702, first reference image data is compared to first test image data, and at 704, second reference image data is compared to second test image data. This comparison can include a pixel to correlating pixel brightness subtraction to generate a difference image, or other suitable comparison procedures. The method then proceeds to 706.

At 706 it is determined whether acceptable variations exist in the compare data, such as by generating a histogram having pixel frequency and magnitude for difference data. If it is determined that the variations are acceptable the method proceeds to 708 where the image data is accepted. Likewise, if the variations are not acceptable the method proceeds to 710.

At 710 a composite test image is formed. In one exemplary embodiment, the composite test image can include two or more sets of image data generated from two or more different illumination angles, from two or more different light frequencies, or other suitable composite test data. The method then proceeds to 712.

At 712 the composite test image data is compared to composite reference image data, such as by performing a pixel to corresponding pixel subtraction or other suitable compare procedures. The method then proceeds to 714.

At 714, three-dimensional coordinates for the component being inspected are estimated from variations in the test image data as compared to the reference image data. For example, pixels at coordinates that have significant variations in brightness as a function of the angle of illumination can indicate the existence of an indentation, spur, bulge, or other deformity in the component. It may be determined by analysis, empirically, or otherwise that such variations in brightness that exceed certain levels correlate to dimensional variations. Likewise, an estimate of the dimensional variation can be calculated from the brightness data and the known angular position of each light source. Other suitable methods may also or alternatively be used. The method then proceeds to 716.

At 716, it is determined whether the variations in the component dimensions are allowable. In one exemplary embodiment, allowable variations can be determined empirically, by calculation, can be set according to a customer or industry standard, or through other suitable methods. The method then proceeds to 718 if it is determined that the variations exceed allowable ranges and the image data is rejected. Likewise, a message can be generated informing the operator that additional analysis or operator inspection is required. If it is determined at 716 that any variations in the image data are allowable then the method proceeds to 720 where the image data is accepted.

In operation, method 700 allows a component to be inspected by illuminating the component from multiple light sources, such that the component generates shaded regions and bright regions. The shaded and bright regions of the component can be then analyzed and compared to reference image data to determine whether unacceptable variations or damage may exist on the component.

Although exemplary embodiments of a system and method for multiple image analysis have been described in detail herein, those skilled in the art will also recognize that various substitutions and modifications can be made to the systems and methods without departing from the scope and spirit of the appended claims.

What is claimed is

1. A system for multiple image analysis comprising:
a first light source;
a second light source;
a camera; and
a multiple image processor coupled to the first light source, the second light source, and the camera, the multiple image processor causing the first light source and the second light source to turn on and the camera to generate two or more sets of image data.

2. The system of claim 1 wherein the first light source emits light having a first frequency and the second light source emits light having a second frequency.

3. The system of claim 2 wherein the camera can generate two or more sets of image data when both the first light source and the second light source are emitting light.

4. The system of claim 2 wherein the camera further comprises:
a first set of pixels receiving light at the first frequency; and
a second set of pixels receiving light at the second frequency.

5. The system of claim 2 wherein the camera further comprises:
a first filter passing light at the first frequency; and
a second filter passing light at the second frequency.

6. The system of claim 1 wherein the multiple image processor further comprises a light sequence controller causing the first light source and the second light source to turn on and turn off.

7. The system of claim 1 wherein the multiple image processor further comprises an image analyzer receiving the two or more sets of image data and generating status data that indicates whether the image data is acceptable.

8. The system of claim 1 wherein the multiple image processor further comprises a first image analyzer receiving the first set of image data and a second image analyzer receiving the second set of image data and generating status data that indicates whether the image data is acceptable.

9. The system of claim 1 wherein the multiple image processor further comprises an image comparator receiving the two or more sets of image data and generating difference data.

10. The system of claim 1 wherein the multiple image processor further comprises an image constructor receiving the two or more sets of image data and generating dimensional variation data.

11. A method for inspecting a component comprising:
illuminating the component from a first illumination angle;
receiving first image data of the component;
illuminating the component from a second illumination angle;
receiving second image data of the component; and
using the first image data and the second image data to determine whether a dimension of the component is acceptable.

12. The method of claim 11 wherein illuminating the component from the first illumination angle and illuminating the component from the second illumination angle further comprises illuminating the component using light having a first frequency from the first illumination angle and illuminating the component using light having a second frequency from the second illumination angle.

13. The method of claim 11 wherein receiving the first image data of the component comprises receiving the first image data of the component by filtering light received from the component.

14. The method of claim 11 wherein receiving the first image data of the component and receiving the second image data of the component comprises receiving the first image data of the component by filtering light received from the component with a first filter and receiving the second image data of the component by filtering light received from the component with a second filter.

15. The method of claim 11 wherein receiving the first image data of the component comprises receiving the first image data of the component with a first set of pixels.

16. The method of claim 11 wherein receiving the first image data of the component and receiving the second image data of the component comprises receiving the first image data of the component with a first set of pixels and receiving the second image data of the component with a second set of pixels.

17. A method for inspecting a component comprising:
receiving first image data and second image data of the component;
comparing the first image data to reference image data to generate first difference data;
comparing the second image data to reference image data to generate second difference data; and
generating component dimension data from the first difference data and the second difference data.

18. The method of claim 17 further comprising:
combining the first image data and the second image data to generate composite image data;
comparing the composite image data to composite reference data to generate composite difference data; and
generating component dimension data from the composite difference data.

19. The method of claim 17 wherein the step of receiving the first image data and the second image data of the component is preceded by the step of receiving status data that indicates that the component requires additional analysis to determine whether it has unacceptable dimensional variations.

20. The method of claim 17 wherein generating the component dimension data from the first difference data and the second difference data further comprises using light source angular data to generate the component dimension data.
